(19) United States
(12) Patent Application Publication
(10) Pub. No.: US 2005/0184053 A1
(43) Pub. Date: Aug. 25, 2005

(54) Method for bonding thermoplastics

(76) Inventors: Andrew S. Wilkinson, Arlesey (GB); Faye C. Smith, Loughton (GB); Andrew J. Miller, Sandy (GB)

Correspondence Address: WHITE & CASE LLP;PATENT DEPARTMENT, 1155 AVENUE OF THE AMERICAS, NEW YORK, NY, 10036, US

(21) Appl. No.: 10/978,314

(22) Filed: Oct. 28, 2004

Related U.S. Application Data
(60) Provisional application No. 60/515,871, filed on Oct. 29, 2003.

(51) Int. Cl. H05B 3/34

(52) U.S. Cl. 219/545

(57) ABSTRACT

A method for bonding thermoplastic substrates is provided. A thin, porous, resistive heater is provided between layers of thermoplastic substrates to be bonded in the absence of an adhesive. The fabric heater is in intimate contact with the substrates at the joint by application of pressure. When the heater is energized, the thermoplastic material at the joint is melted or softened, and becomes uniformly distributed in the weld. After cooling, the fabric heater remains within the weld area and provides increased reinforcement to the weld bond.

### CROSS-REFERENCE TO RELATED APPLICATIONS

This application claims priority to U.S. provisional patent application Ser. No. 60/515,871, filed Oct. 29, 2003, the contents of which are incorporated herein in their entirety.

### FIELD OF THE INVENTION

The present invention relates to a method for bonding thermoplastic substrates without an adhesive to form articles of manufacture. In accordance with the invention, a heater comprising an electrically conductive fabric is placed in intimate contact with the surfaces of substrates to be joined. Upon energization, the heater provides the heat necessary to melt the thermoplastic surfaces at the bondline so that the surfaces bond upon application of pressure. The fabric heater can be energized using any appropriate means, such as physical conduction or induced electromagnetism. The fabric heater also acts as a reinforcing layer when the welding process is complete.

### BACKGROUND OF THE INVENTION

The design and manufacture of light-weight, multi-component structures have increasingly relied upon the use of composites and, more specifically, the joining of component parts using adhesives, traditional welding systems, and/or mechanical fasteners.

There are several technologies available for joining thermoplastic materials. These technologies fall into three general categories: mechanical movement, external heat sources, and electromagnetism.

Mechanical methods require friction heat or ultrasonic movement to join two or more thermoplastic parts.

External heating methods are commonly used because of their simplicity. Electrical heating or hot gases can be used to generate the heat required to bond the substrates. The most common heat method is hot plate welding. In this method, a heat source, e.g. a metal plate, is placed between the two target materials to be joined. The radiant heat supplied from the source to the target is sufficient to cause localized melting at the thermoplastic surface. After the heat source is removed, the parts to be joined are brought into contact with each other, and the bondline is formed.

One method of using electrical heating is disclosed in co-pending U.S. patent application Ser. No. 10/607,422, published as U.S. 2004/0055699. In accordance with this method, an electrically conductive fabric heater and a layer of a thermally curable adhesive are applied between the surfaces of the structures to be bonded. The heater is then energized to produce heat at the bondline and at the curing temperature of the adhesive to cure the adhesive. Although U.S. 2004/0055699 provides a bonding method having significant benefits over previously-known methods, it may be desirable in certain applications to bond structures in the absence of an adhesive.

Electromagnetism methods utilize a conductive implant, such as a foil or wire placed in or near the bondline. The implant is subjected to an electromagnetic field, which induces an electrical current and causes the implant to heat, providing the energy to melt the polymers together. However, irregular heat patterns can occur using such methods. For example, heating a serpentine wire implant causes the areas directly adjacent to the wire to be hotter than areas further away, resulting in overheated areas and underheated areas having poor bonding and inadequate joint strength. In addition, the heating means used for bonding structures by induction heating typically require equipment that cannot be readily transported if repairs are necessary.

Present methods for bonding plastic structures using heaters have not been adequate or practical to generate high strength bonds or bonds that do not degrade. Therefore, new methods are needed to produce articles of manufacture with improved and relatively high structural bond strength. The present invention seeks to overcome the disadvantages encountered by the prior art methods.

### SUMMARY OF THE INVENTION

The present invention provides a method for bonding thermoplastic structures, such as articles of manufacture requiring high structural bond strength. The method comprises disposing or applying, in the absence of an adhesive, an electrically conductive fabric heater at a bondline between substrates to be bonded; and applying pressure to the substrates and electrical energy to the heater to heat the bondline to the melting temperature of the substrates so that the surfaces of the substrates at the bondline are melted and the two substrates bond together. After the substrates are bonded, the heater is de-energized and the bondline is allowed to cool to ambient temperature.

In the method of the invention, a thin resistive heater comprising an electrically conductive fabric is disposed between the substrates to be joined. The fabric heater comprises a fabric, such as a non-woven mat comprising electrically conductive fibers. Alternatively, the fabric heater itself can be coated with a metal or comprise metal-coated fibers. Any of the fibers forming the heater can be uncoated, or coated with a metal such as nickel, copper, silver, brass or gold.

The fabric heater can be of different sizes and shapes depending on the characteristics of the joint structure to be bonded. The fabric heater used in the invention provides a uniform distribution of heat at the bondline so that the surfaces of the structures to be bonded melt or soften in a homogeneous and/or simultaneous manner. The process can be performed in a single step and comprises a simple control system to regulate local temperature.

Advantageously, the present invention provides a method of bonding thermoplastic substrates wherein the heater provides a uniform heat source during bonding, and when bonding is complete, the heater functions as a fibrous reinforcement between the bonded layers that does not degrade the bond properties. Since the present process does not require the use of adhesives, temperatures lower than the curing temperature of the adhesive can be used, thereby making the process more cost and energy efficient. Notwithstanding the absence of an adhesive, the articles of manufacture produced using this method contain bonds with relatively high structural strength.

Since the fabric heater remains at the joint or as part of the bondline and is unobtrusive in the structure, the fabric heater does not degrade the bondline, but rather contributes to the strength of the bond between the welded substrates. The use of metal-coated fibers in certain embodiments of the invention, such as nickel-coated carbon fibers, allows for a resistance feedback control bonding process which is advantageous for monitoring the bond or weld.

The method of the invention can be embodied in various ways. For example, in a longitudinal embodiment of the invention, the bondline is prepared such that the electrical current runs parallel to the bondline. In this aspect of the invention, most commercially available power supplies can be used to provide power to the heater. This embodiment can be used for smaller applications and with substrates which do not contain conductive reinforcement.

In another embodiment of the invention, a transverse bonding arrangement is used. In this embodiment, the electrical current runs transverse to the bondline. A transverse arrangement can be applied when using conductive, reinforced thermoplastics as substrates, and for large applications. In a further embodiment, a single fabric heater can be replaced by several heaters to provide zone heating, and each zone heater can be powered independently so that the arrangement uses lower power levels in low voltage applications.

In another embodiment of the invention, the bonding process is carried out using an induction method. In this aspect of the invention, the fabric heater is placed between the substrates to be bonded as described above, and induction coils and a generator are set up at a predetermined distance from the bondline. In this embodiment, the fabric heater acts as the susceptor, and when the system is in operation and the bond area is pressurized, sufficient local heat is generated by the fabric heater to melt the thermoplastic substrates at the bondline.

In accordance with another aspect of the present invention, an article of manufacture is obtained according to the method of the invention.

A thermoplastic substrate in this discussion is to be understood as any material having the property of softening or fusing when heated and of hardening and becoming rigid again when cooled. Examples of thermoplastics substrates which can be successfully used in the present invention include, but are not limited to, thermoplastic polymers such as urethanes, polyethers, and polyaramids, as further discussed below.

It is to be understood that the terms “thermoplastic”, “substrate”, “thermoplastic substrate”, “resin”, “laminate”, and “polymer” as used in this specification are alternative and equivalent terms for substrates comprised of one or more thermoplastic materials.

### BRIEF DESCRIPTION OF DRAWINGS

FIG. 1 is a schematic diagram of a cross section of two thermoplastic substrates and a fabric heater in a bonding assembly according to an embodiment of the invention.

FIG. 2 is a schematic diagram of the bonding assembly shown in FIG. 1 as seen from above and connected to a power source.

FIG. 3 is a schematic representation in a longitudinal plane of a bonding assembly for induction bonding of thermoplastic pipes, according to another embodiment of the invention.

### DETAILED DESCRIPTION

Thermoplastic substrates can be bonded together by heating the bondline to near or above the thermoplastic melt temperature while applying pressure to the substrates being bonded. Upon cooling, the resin hardens and forms a bonded joint between the two thermoplastic surfaces. In the method of the invention, an electrically conductive fabric heater sandwiched between the substrates is used as a means for heating the bondline area prior to bonding.

In an embodiment of the invention, a method for bonding thermoplastic substrates comprises applying a fabric heater element between the bonding surfaces of at least two structures to be bonded, wherein the heater comprises an electrically conductive fabric and two bus bars. Electrical leads are applied to each of the bus bars by conventional methods, and are connected to a power source. The heater is energized to produce heat evenly throughout the bondline, thereby increasing the local temperature at the bondline, to or at about the melting temperature of the substrates. Pressure is applied as the substrates melt at the bondline. After bonding has occurred, the power source is turned off and the bondline is allow to cool. After cooling, any excess material containing the bus bars is removed and the bonding is complete.

The substrates used in the present invention can be comprised of any type of thermoplastic resin, polymer, or laminate which softens upon application of heat and pressure. For example, polyurethanes, polyolefins, polyesters, polyethers, polyaramid, and other types of polymers can be used as substrates. The substrates can be a homopolymer or a copolymer, such as a block or alternating copolymer, or a laminate.

The substrates to be joined can be formed from the same thermoplastic material, or can be blends or layers of two or more different materials, and may also comprise a conductive reinforcement material for increased strength. In addition, the substrates can be formed by disposing a thermoplastic coating layer on a solid material. The solid material can be a non-thermoplastic substance, such as concrete or wood, or the solid material can be another thermoplastic substance which has similar or different physical properties as the coating layer.

There is no limitation on the size, shape, or other physical dimensions of the substrates to be bonded. The bonding substrates can be planar, rounded, rough, smooth, or have surface projections to facilitate melting or softening of the thermoplastic.

The amount of compression force or pressure which is applied to the substrates during fusion will depend upon the particular applications, as certain substrates will require more pressure to fuse than will other substrates. It is envisioned that pressures in the range of 1 bar to 100 bar (15 psi to 1,500 psi) will be typical in the performance of the invention. Compression forces can be applied using any convenient means, such as clamps, jigs, vices, or vacuum bag compression, without limitation.

The amount of heat produced by the fabric heater, and the corresponding elevated temperatures obtained, will depend upon the particular selection of the thermoplastic substrates to be bonded, as well as the characteristics of the heater. Different thermoplastic substrates will have different melting or softening temperatures which are known to those of ordinary skill in the art. In this regard, the substrates do not need to be partially or completely melted to effect a strong bond. That is, strong bonds at the bondline can also be obtained when the thermoplastic substrates partially or substantially soften under the application of heat and pressure. The elevated pressure and temperature cause the softened substrates to flow into the fabric heater and thereby form the secure bondline. Typical temperatures are envisioned to be in the range of 150° C.-600° C. (300° F. to 1100° F.), although the temperature can be higher or lower than this range depending on individual circumstances.

The fabric heater can comprise a single heater disposed between the substrate layers, or a plurality of heaters can be used to melt or soften the thermoplastic substrates. If a plurality of heaters are used, e.g. for zone heating, each heater can have different physical or mechanical properties, such as different shapes, heat output, porosity or density, in order to obtain optimum zone heating characteristics.

The heating time and amount of energy supplied to the fabric heater to join the substrates will depend on the particular substrates to be joined. In general, the fabric heater needs to be energized for only a short period of time to soften or melt the thermoplastic substrate, thereby advantageously minimizing the amount of energy necessary. For example, in certain embodiments of the invention, several seconds of heating are sufficient to soften and weld the two substrates together. In other embodiments, several minutes of heating at a lower power setting may be desirable to join the substrates.

The fabric heater used in the present invention may comprise a woven or non-woven mat of electrically conductive fibers, e.g., carbon fibers. The electrically conductive fibers forming the mat may be uncoated, or coated with a metal such as copper, brass, silver, nickel, or gold. Alternatively, the fabric heater itself can be coated with a metal or comprise metal-coated fibers. In one embodiment of the invention, the electrically conductive fabric is non-woven and comprises uncoated or nickel-coated carbon fibers. The fabric heater may optionally comprise an organic or inorganic binder to enhance its structural stability. An example of an organic binder is a thermosetting polymer, and an example of an inorganic binder is an alumina sol.

In an embodiment of the invention, the fabric heater of the invention comprises a very thin fabric which is approximately 0.1 mm (4 mil) in thickness. An example of a commercially-available fabric heater which can be used in the invention is Thermion™ NCCF.

There are several distinct advantages of using an electrically conductive fabric heater for bonding thermoplastics. One particular advantage of using an electrically conductive fabric heater is that the heater heats the entire bond area uniformly, compared to prior art techniques in which non-uniform heating of a bond area was obtained. The heater is also generally thin, porous and flexible, and therefore does not detrimentally affect the bond properties after fusion. In addition, the fabric heater is compatible with thermoplastic resin systems.

The electrically conductive fibers comprising the fabric heater cover a low percentage of the heater's surface area, i.e., there are many ‘gaps’ between the fibers. As the melting or softening temperature of the thermoplastic substrates is reached, the molten or softened resin encounters little resistance passing through the gaps of the fabric, and easily passes through the gaps to both sides of the heater. In this aspect of the invention, the fabric heater allows excellent wetting out in the polymer. Additionally, the fabric heater of the invention does not degrade or foul the mechanical robustness of the bondline as can happen with other implant weld technology. Although the typical thickness of the fabric heater is in the range of from 0.05-0.15 mm (2-6 mil), fabric heaters of any type or thickness are encompassed by the invention. The fabric heater of the invention does not require hot gases to melt the polymer, thereby enabling the present invention to be used for bonding applications in hazardous environments.

The fabric heater implant provides local, consistent and uniform heat across the entire joint area. The resistivity of the heater can be tailored by adjusting, for example, the metal content or the mass per unit area of the base fabric when using metal or metal-coated fabrics or fibers. In such an embodiment, the design flexibility of the bond joint is increased, and the bonding process can be controlled more easily and precisely compared to prior art methods.

The fabric heater does not require complex equipment to obtain power. In the case of bus bar conduction, an AC or DC power supply is generally sufficient. For induction heating, a suitable frequency source and coil will be required. Copper bus bars can be used to spread the current along the width of the heater.

The fabric heater can also be pre-encapsulated in a polymer or thermoplastic that is the same as, or compatible with, one or more of the substrates. Pre-encapsulation allows the fabric heater to be more easily handled in industrial applications.

Since the fabric heater remains at the joint or as part of the bondline and is unobtrusive in the structure, the fabric heater does not degrade the bondline, but rather contributes to the strength of the bond between the welded substrates. The use of metal-coated fibers, such as nickel-coated carbon fibers in certain embodiments of the invention, allows for a resistance feedback control bonding process, which is advantageous for monitoring the bond or weld.

Although the invention has been described as comprising a single fabric heater sandwiched between two substrates, in alternative embodiments of the invention, a plurality of layers can be used to form the structure. For example, two fabric heaters can be alternated between three layers of substrate. Any such embodiments comprising a plurality of alternating layers of fabric heaters and substrates are encompassed by the invention. In addition, a plurality of individual substrates sections can be used to form a single layer. For example, one layer can comprise two separate sections which are placed immediately adjacent to each other. This embodiment permits the buildup of a structure from smaller sections which may, for example, be more easily manufactured than a single larger substrate layer. The separate layer sections may be manufactured from the same, or different but compatible, materials.

The claimed invention will now be described with reference to the Figures.

### EXAMPLE 1

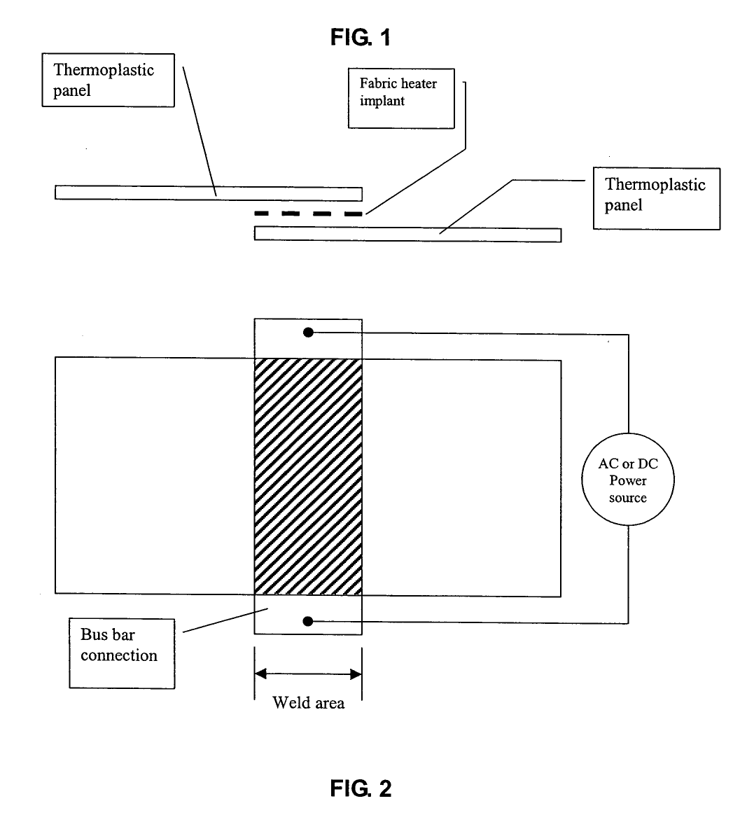

One embodiment of a typical bonding arrangement according to the invention is illustrated in FIGS. 1 and 2. FIG. 1 shows a cross-sectional view of two thermoplastic substrates bonded by the method of the invention. FIG. 1 depicts a longitudinal arrangement of two panels of thermoplastic material joined utilizing a non-woven fabric heater in the form of a joining tape. In one embodiment, the thermoplastic material is a glass reinforced polypropylene-based thermoplastic, and the fabric heater comprises nickel-coated carbon fibers. The two thermoplastic panels are partly overlapped to create the bond area. The fabric heater is placed in between the two panels and has a greater length than the panel width. FIG. 2 illustrates the arrangement shown in FIG. 1 when viewed from above. In FIG. 2, the bus bars are attached to the excess fabric heater extending from the joint to create an electrical circuit. The bus bars, fabric heater and the panels are compressed together using clamps, jigs or a vacuum bag. A voltage is applied across the fabric heater causing current to flow and the fabric heater to resistively heat. The power is set to about 50 W/in and the temperature at the joint is raised in excess of 280° C. (540° F.) for 1 minute under pressure. After bonding, the power is disconnected and the weld area or bondline is allowed to cool to ambient temperature.

### EXAMPLE 2

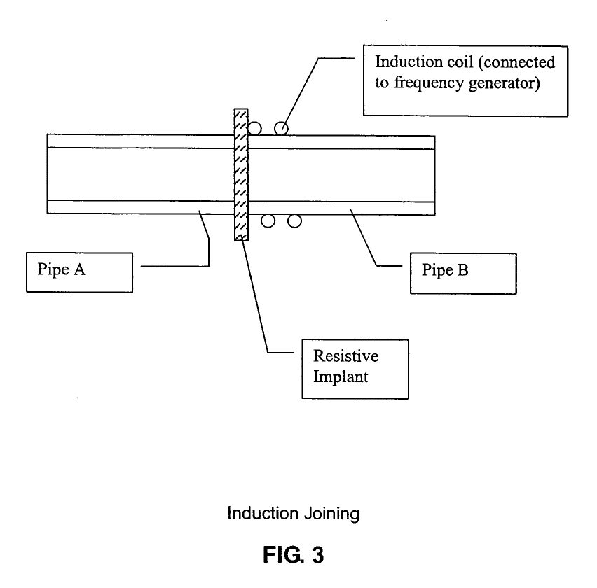

FIG. 3 shows a bonding setup using induction heating according to a second embodiment of the invention. FIG. 3 shows the joining of two pieces of plastic pipe. The resistive fabric heater in this example has been manufactured from a resistive fabric and a compatible polymer. For example, if the pipes are polyethylene water pipes, the resistive fabric will be laminated in polyethylene.

The pipes are placed together and compressed using a custom-made jig. The fabric heater implant is dimensioned larger than the pipe diameter. The fabric heater implant is energized to the required power density (for example, in the region of 50W/in) and the pipes are forced together and held for at least 30 seconds to allow the weld or bondline to form.

Numerous modifications and variations of the present invention are possible in light of the above teachings, and therefore, within the scope of the appended claims, the invention may be practiced otherwise than as particularly described.

1. A method for bonding thermoplastic substrates, comprising:
disposing an electrically conductive fabric heater at a bondline between substrates to be bonded in the absence of an adhesive, wherein the substrates comprise a thermoplastic material,
applying pressure to the substrates at the bondline such that the fabric heater is sandwiched between the substrates,
energizing the fabric heater to raise the temperature of the substrates at the bondline to or at about the melting temperature of the thermoplastic material, and
allowing the bondline to cool,
wherein the fabric heater becomes part of the bonded substrates.

2. The method according to claim 1, wherein the substrates comprise the same or different thermoplastic material.

3. The method according to claim 1, wherein the fabric heater and at least one of the substrates are comprised of the same thermoplastic material.

4. The method according to claim 1, wherein at least one of the substrates further comprises a conductive reinforcement material.

5. The method according to claim 1, wherein at least one of the thermoplastic substrates comprises a thermoplastic coating layer disposed on a thermoplastic or non-thermoplastic solid material.

6. The method according to claim 1, wherein the fabric heater comprises a woven or non-woven fabric.

7. The method according to claim 6, wherein the woven or non-woven fabric is comprised of uncoated or metal-coated electrically conductive fibers.

8. The method according to claim 1, wherein the fabric heater comprises uncoated or metal-coated electrically conductive fibers.

9. The method according to claim 8, wherein the metal is selected from the group consisting of copper, brass, silver, nickel, and gold.

10. The method according to claim 8, wherein the conductive fibers are carbon fibers.

11. The method according to claim 1, wherein the fabric heater is coated with a metal or comprises metal-coated fibers.

12. The method according to claim 11, wherein the metal is selected from the group consisting of copper, brass, silver, nickel, and gold.

13. The method according to claim 1, wherein the fabric heater comprises nickel-coated carbon fibers.

14. The method according to claim 1, wherein the fabric heater comprises an organic or inorganic binder.

15. The method according to claim 14, wherein the organic binder is a thermosetting polymer.

16. The method according to claim 14, wherein the inorganic binder is an alumina sol.

17. The method according to claim 1, wherein the fabric heater is energized by physical conduction or induced electromagnetism.

18. The method according to claim 1, wherein the fabric heater is energized by an electric current running parallel or transverse to the bondline.

19. An article of manufacture prepared according to the method to any one of claims 1-18.
